(19) United States
(12) Patent Application Publication
(10) Pub. No.: US 2026/0245188 A1
(43) Pub. Date: Aug. 20, 2026

(54) METHOD, APPARATUS, DEVICE AND STORAGE MEDIUM FOR IMAGE PROCESSING

(71) Applicant: Beijing Zitiao Network Technology Co., Ltd., Haidian District, Beijing (CN)

(72) Inventor: Qianqian Wang, Beijing (CN)

(21) Appl. No.: 19/160,447

(22) PCT Filed: Feb. 20, 2024
(86) PCT No.: PCT/CN2024/077809

§ 371 Date: Aug. 27, 2025

(30) Foreign Application Priority Data
Feb. 28, 2023 (CN) 202310215037.5

(51) Int. Cl. G06T 5/77; G06T 3/40; G06T 7/12; G06T 7/13; G06V 10/75

(52) U.S. Cl. CPC G06T 5/77; G06T 3/40; G06T 7/12; G06T 7/13; G06V 10/751

(57) ABSTRACT

Embodiments of the disclosure relates to a method, an apparatus, a device and a storage medium for image processing, the method includes obtaining a first image; in response to an operation of a user, determining a region to be repaired of the first image; generating a second image by performing an edge information extraction processing on the first image; determining, in accordance with an image block to be repaired of the region to be repaired and an edge information image block in the second image, a target image block having a highest matching degree with the image block to be repaired; and obtaining a target repair image by repairing the region to be repaired based on the target image block.

### CROSS-REFERENCING OF RELATED APPLICATIONS

This application claims priority to Chinese Patent Application No. 202310215037.5, filed on Feb. 28, 2023, and entitled “METHOD, APPARATUS, DEVICE AND STORAGE MEDIUM FOR IMAGE PROCESSING”, the entirety of which is incorporated herein by reference.

### FIELD

Embodiments of the present disclosure relate to the field of computer technologies, and in particular, to a method, an apparatus, a device and a storage medium for image processing.

### BACKGROUND

Image repairing refers to reconstructing missing parts in an image, which has a wide application scenario. For example, for a scene in which there is a region to be repaired in the image due to the missing of the image content caused by reasons such as the erasure of the erase pen or the loss of the data packet in the image output process, the image repairing technique may be used to repair the region to be repaired to obtain a complete image.

At present, image repairing is usually searching for image content similar to the region to be repaired from a non-to-be-repaired region in the image according to RGB information, and filling the found image content to the region to be repaired. However, when there is a line in the region to be repaired, the problem of the line in the original region to be repaired and the original non-to-be-repaired region in the image after image repairing cannot be aligned may exist, resulting in the poor image repairing effect. There is no effective solution for the problem.

### SUMMARY

In order to solve the foregoing technical problem or at least solve a part of the foregoing technical problem, embodiments of the present disclosure provide a method, an apparatus, a device and a storage medium for image processing.

A first aspect of embodiments of the present disclosure provides a method for image processing, the method comprising:
obtaining a first image;
in response to an operation of a user, determining a region to be repaired of the first image;
generating a second image by performing an edge information extraction processing on the first image;
determining, in accordance with an image block to be repaired of the region to be repaired and an edge information image block in the second image, a target image block having a highest matching degree with the image block to be repaired; and
obtaining a target repair image by repairing the region to be repaired based on the target image block.

A second aspect of embodiments of the present disclosure provides an apparatus for image processing, the apparatus comprising:
a first obtaining module configured to obtain a first image;
a first determining module configured to in response to an operation of a user, determine a region to be repaired of the first image;
a generating module configured to generate a second image by performing an edge information extraction processing on the first image;
a second determining module configured to determine, in accordance with an image block to be repaired of the region to be repaired and an edge information image block in the second image, a target image block having a highest matching degree with the image block to be repaired; and
a repairing module, configured to obtain a target repair image by repairing the region to be repaired based on the target image block.

A third aspect of embodiments of the present disclosure provides an electronic device, the server comprising: a processor and a memory, wherein the memory stores a computer program, when the computer program is executed by the processor, the processor performs the method of the foregoing first aspect.

A fourth aspect of embodiments of the present disclosure provides a computer-readable storage medium storing a computer program, and when the computer program is executed by a processor, the method of the foregoing first aspect may be implemented.

A fifth aspect of embodiments of the present disclosure provides a computer program product, comprising a computer program or an instruction, when the computer program or the instruction is executed by a processor, the method of the foregoing first aspect may be implemented.

Compared with the existing technology, the technical solution provided by embodiments of the present disclosure has the following advantages:

According to embodiments of the present disclosure, a first image can be obtained; in response to an operation of a user, a region to be repaired of the first image can be determined; a second image can be generated by performing an edge information extraction processing on the first image; in accordance with an image block to be repaired of the region to be repaired and an edge information image block in the second image, a target image block having a highest matching degree with the image block to be repaired can be determined; a target repair image can be obtained by repairing the region to be repaired based on the target image block.

### BRIEF DESCRIPTION OF DRAWINGS

The accompanying drawings herein are incorporated in and constitute a part of the specification, illustrating embodiments accorded with the present disclosure, which is used to explain the principles of the present disclosure together with the specification.

In order to more clearly illustrate embodiments of the present disclosure or the technical solutions in the existing technology, the accompanying drawings need to be used in the description of embodiments or the existing technology will be briefly introduced below, and it will be apparent that those skilled in the art may also obtain other drawings according to these drawings without creative labor.

FIG. 1 is a flowchart of a method for image processing provided by embodiments of the present disclosure;

FIG. 2 is a schematic diagram of a first image provided by embodiments of the present disclosure;

FIG. 3 is a schematic diagram of a second image provided by embodiments of the present disclosure;

FIG. 4 is a schematic diagram of a first image after repairing provided by embodiments of the present disclosure;

FIG. 5 is a schematic flowchart of another method for image processing provided by embodiments of the present disclosure;

FIG. 6 is a schematic logical diagram of determining a candidate matching region provided by embodiments of the present disclosure;

FIG. 7 is a schematic structural diagram of an apparatus for image processing provided by embodiments of the present disclosure; and

FIG. 8 is a schematic structural diagram of an electronic device in embodiments of the present disclosure.

### DETAILED DESCRIPTION

In order to more clearly understand the above objects, features and advantages of the present disclosure, the solutions of the present disclosure will be further described below. It should be noted that, in the case of no conflict, embodiments and the features in embodiments of the present disclosure may be combined with each other.

Many specific details are set forth in the following description to facilitate a thorough understanding of the present disclosure, but the present disclosure may also be implemented in other ways other than those described herein; it is apparent that embodiments in the specification are only part of embodiments of the present disclosure, not all embodiments.

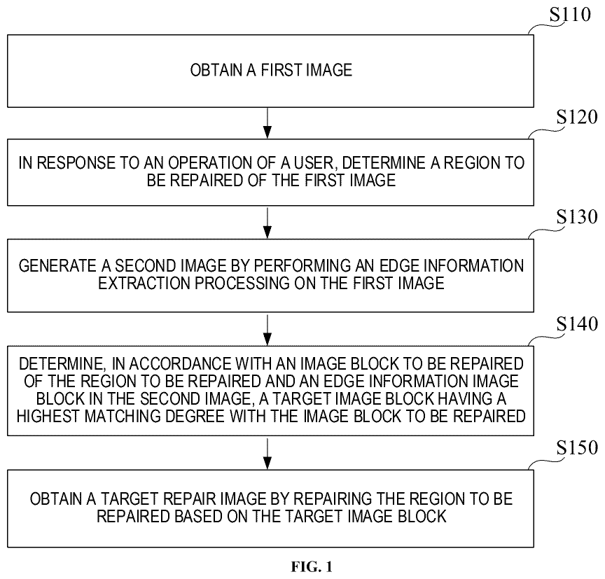

FIG. 1 is a flowchart of a method for image processing provided by embodiments of the present disclosure, and the method may be performed by an electronic device, which is applicable for a scenario of performing image repairing on the image. As an example, the electronic device may be understood as but not limited to a device such as a mobile phone, a tablet computer, a notebook computer, a desktop computer, or a smart television.

As shown in FIG. 1, the method provided by embodiments includes the following steps:

S110: obtain a first image.

In some embodiments, S110 may include but not limited to: receiving a first image sent by another electronic device; or reading the first image from a storage device.

S120: in response to an operation of a user, determine a region to be repaired of the first image.

Specifically, the region to be repaired refers to the region which consists of unknown pixels.

Respectively, the first image further includes a non-to-be-repaired region, and the non-to-be-repaired region refers to an region in the first image which consists of known pixels.

In some embodiments, S120 may include: in response to an erase operation by a user based on the erase pen, determining an region to be erased by the erase operation as a region to be repaired; or in response to a trigger operation on the recognition control for the region to be repaired by the user, recognizing a region to be repaired in the first image. However, it is not limited to this.

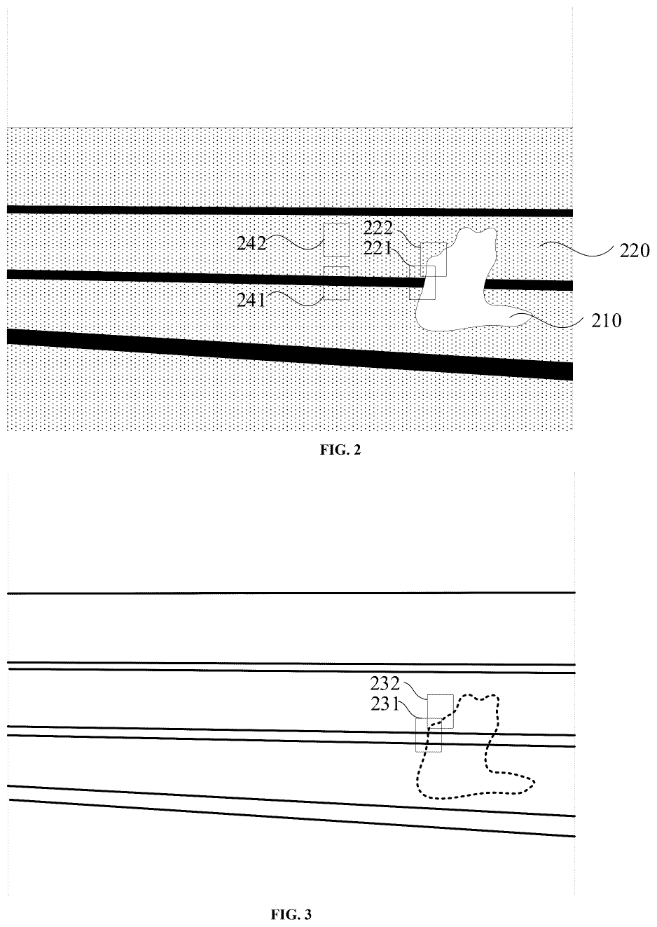

For example, FIG. 2 is a schematic diagram of a first image provided by embodiments of the present disclosure. As shown in FIG. 2, since there is a cat located on the playground running track when taking pictures of the playground running track, the captured image includes a cat, then the user may erase the cat in the image by the erase pen, and since the pixels in the erased region become unknown pixels, the first image includes the region to be repaired 210 and the non-to-be-repaired region 220.

S130: generate a second image by performing an edge information extraction processing on the first image.

Specifically, the second image is used to represent the line feature of the first image. The second image includes a portion representing a line feature of the region to be repaired and a portion representing a line feature of the region to be repaired, where “the line feature of the region to be repaired” herein refers to a line feature corresponding to the region to be repaired if repaired.

Specifically, the size of the second image and the first image are the same, and the grayscale values of the pixels corresponding to the lines in the second image are different from the grayscale values of other pixels, so as to clearly show the lines. However, it is not limited to this.

For example, FIG. 3 is a schematic diagram of a second image provided by embodiments of the present disclosure. As shown in FIG. 2 and FIG. 3, the edge information extraction processing is performed on FIG. 2 to generate FIG. 3 representing the line features of FIG. 2, where FIG. 3 includes not only the image region representing the line feature of the region to be repaired, but also the image region representing the line feature of the non-to-be-repaired region, and the size of FIG. 2 and FIG. 3 are the same, the grayscale value of the pixel corresponding to the line in FIG. 3 is 0 (in black), and the grayscale value of the other pixel is 255 (in white).

In some embodiments, a low-resolution repair may be performed on the region to be repaired of the first image to obtain a third image, and an edge information extraction processing may be performed on the third image to obtain the line feature of the region to be repaired and the line feature of the non-to-be-repaired region, where the “low-resolution repair” herein refers to the resolution of the third image obtained by repairing being smaller than the resolution of the first image; and the second image is generated according to the line feature of the region to be repaired and the line feature of the non-to-be-repaired region.

In one example, a trained machine learning model may be used to perform low-resolution repair on the region to be repaired of the first image. Accordingly, S120 may include:

S121: obtain a first model for performing a low-resolution repair on a region to be repaired in an image.

Specifically, the first model is generated in advance by training according to the region to be repaired in the image sample set and the corresponding low-resolution repair region.

Specifically, the first model may be any possible type of machine learning model, which is not limited herein.

Specifically, the training process of the first model may include: obtaining a sample image set, where the sample image set includes a first sample image and a corresponding first label image, the first sample image includes a region to be repaired and a non-to-be-repaired region, and the first label image includes a low-resolution repair region obtained by performing a low-resolution repair on a region to be repaired in the first sample image and a non-to-be-repaired region; inputting the first sample image into the first model for processing, to output a low-resolution repair image by performing low-resolution repair on the region to be repaired, and calculating a loss function of the first model according to the first label image and the corresponding low-resolution repair image; and if the loss function of the first model does not satisfy the predetermined training end condition of the first model, then adjusting parameters in the first model until the loss function of the first model satisfies the predetermined training end condition of the first model. However, it is not limited to this.

S122: obtain a third image by inputting the first image into the first model.

Specifically, the first image is input into the first model for processing, and the third image after performing the low-resolution repair on the region to be repaired is output.

S123: generate the second image by performing an edge information extraction processing on the third image.

Specifically, edge information extraction processing may be performed on the third image by using a predetermined edge extraction operator to generate the second image. The predetermined edge extraction operator may be any possible edge extraction operator, such as a canny operator or a sobel operator, but is not limited thereto.

Certainly, in another example, a predetermined low-resolution repair algorithm may also be used to perform a low-resolution repair on the image missing region of the first image, but is not limited thereto.

It can be understood that, since the low-resolution repair is relatively rough repair, the repair efficiency is high and the required computing resources are small, so that the third image by low-resolution repair may be quickly obtained, which is beneficial to improving the obtaining efficiency of the second image representing the feature of the first image line, thereby improving the overall image repair efficiency, and the performance requirement on the electronic device is relatively low, which is beneficial to the promotion of the image repair method on the low-end electronic device.

It can be further understood that performing a low resolution repair on the region to be repaired by using a machine learning model (that is, the first model), may cause the accuracy of the low-resolution repair to be higher, which is beneficial for extracting more accurate line features of the region to be repaired, thereby laying a foundation for performing subsequent delicate and accurate repair on the first image.

In some other embodiments, the line feature of the region to be repaired may be inferred according to the non-to-be-repaired region, and edge information extraction processing may be performed on the non-to-be-repaired region to obtain the line feature of the non-to-be-repaired region; and the second image may be generated according to the line feature of the region to be repaired and the line feature of the non-to-be-repaired region.

In one example, the line feature of the region to be repaired may be inferred by using a trained machine learning model and performing edge information extraction processing on the non-to-be-repaired region. Respectively, S120 may include:

S1221: obtain a second model used to perform edge extraction on the image including the region to be repaired.

Specifically, the second model is generated by pre-training according to the missing image sample set and the image line feature corresponding to the complete image.

Specifically, the second model may be any possible type of machine learning model, which is not limited herein.

Specifically, the training process of the second model may include: obtaining a missing sample image set including a second sample image and an image line feature corresponding to the complete image, where the second sample image includes a region to be repaired and a non-to-be-repaired region, and the second sample image is obtained by performing erasing processing on a partial image region of the complete image; inputting the second sample image into the second model for processing, outputting an image representing the second sample image line feature, and calculating a loss function of the second model according to the image representing the line feature of the second sample image and the image line feature corresponding to the complete image; and if the loss function of the second model does not satisfy the predetermined training end condition of the second model, then adjusting the parameter in the second model until the loss function of the second model satisfies the predetermined training end condition of the second model. However, it is not limited thereto.

S1222: obtain a second image by inputting the first image into the second model.

Specifically, the first image is input into the second model for processing, and the second image representing the line feature of the first image is output.

It can be understood that the line feature of the region to be repaired is inferred according to the non-to-be-repaired region and the edge information extraction process is performed on the non-to-be-repaired region, so that the second image representing the line feature of the first image may be directly obtained, in this case, it is beneficial for improving the obtaining efficiency of the second image, and the overall image repair efficiency is improved.

It can be further understood that the first image is processed by using a machine learning model (that is, the second model), and the line feature of the region to be repaired may be extracted more accurately, thereby laying a foundation for performing subsequent fine and accurate repair on the first image.

S140: determine, in accordance with an image block to be repaired of the region to be repaired and an edge information image block in the second image, a target image block having a highest matching degree with the image block to be repaired.

Specifically, the image block to be repaired is partially in the region to be repaired and partially in the non-to-be-repaired region, and therefore, the image block to be repaired includes the known pixel and the unknown pixel. The adjacent image blocks to be repaired may overlap or may not overlap with each other, which is not limited herein.

Specifically, the position of the edge information image block in the second image is the same as the position of the corresponding image block to be repaired in the first image. The position of the image block to be repaired in the first image may be represented by coordinates of all pixels in the image block to be repaired in the first image, represented by a coordinate of the pixel at each vertex of the image block to be repaired in the first image, or represented by a coordinate of the pixel at the center of the image block to be repaired in the first image and a size of the image block to be repaired, but is not limited thereto. It is similar for the position of the edge information image block in the second image, and details are not described herein again.

In some embodiments, the method further includes: dividing an image block to be repaired comprising a known pixel and an unknown pixel in accordance with an edge of the region to be repaired; obtaining an edge information image block corresponding to the image block to be repaired at a same position in the second image based on a position of the image block to be repaired in the first image.

As an example, continue to referring to FIG. 2 and FIG. 3, a plurality of image blocks to be repaired are divided according to the edge of the region to be repaired 210, and an edge information image block corresponding to the image block to be repaired is obtained at the same position in the second image based on the position of the image block to be repaired in the first image. It should be noted that, for convenience of drawing, only the first image block to be repaired 221 and the second image block to be repaired 222 are shown in FIG. 2, and accordingly, only the first edge information image block 231 corresponding to the first image block to be repaired 221 and the second edge information image block 232 corresponding to the second image block to be repaired 222 are shown in FIG. 3, and other image blocks to be repaired are not shown and not all the edge information image blocks are shown.

In some other embodiments, the method further includes: in response to the dividing operation performed by the user for image block to be repaired in the first image, dividing the image block to be repaired including the known pixel and the unknown pixel; and obtaining an edge information image block corresponding to the image block to be repaired at a same position in the second image based on a position of the image block to be repaired in the first image.

Specifically, the target image block is an image block that is located in the non-to-be-repaired region and has the highest matching degree with the image block to be repaired, where “matching degree” herein refers to a combination of the matching degree with the known pixel of the image block to be repaired and the matching degree with the edge information of the edge information image block.

In some embodiments, S140 may include: obtaining a third model for matching the target image block, where the third model is generated by pre-training in advance according to the image block to be repaired, the edge information image block, and the corresponding image block having the highest matching degree in the image sample set; and inputting the image block to be repaired and the edge information image block into the third model for processing, and outputting the target image block having the highest matching degree with the image block to be repaired.

As an example, continue to referring to FIG. 2 and FIG. 3, the first target image block 241 having the highest matching degree with the first image block to be repaired 221 is determined according to the known pixel of the first image block to be repaired 221 and the edge information of the first edge information image block 231, and the second target image block 242 having the highest matching degree with the second image block to be repaired 222 is determined according to the known pixel of the second image block to be repaired 222 and the edge information of the second edge information image block 232. It is similar for other image blocks to be repaired not shown in FIG. 2, details are not described herein again.

S150, obtain a target repair image by repairing the region to be repaired based on the target image block.

In some embodiments, repairing the image block to be repaired based on the target image block may include: determining, in the target image block, a first pixel region corresponding to a known pixel in the image block to be repaired and a second pixel region corresponding to an unknown pixel in the image block to be repaired; and filling a pixel value of the second pixel region into a corresponding position of an unknown pixel in the image block to be repaired, and performing an update processing on a corresponding position of a known pixel in the image block to be repaired based on a pixel value of the first pixel region. Of course, it may also be not performing the update processing on the known pixel in the image block to be repaired, which is not limited thereto.

It can be understood that performing the update processing on the unknown pixel and the known pixel in the image block to be repaired may cause the pixel value of the image block to be repaired to be more matched, and more harmonious.

Optionally, after S150, the repair processing may be continued based on the new region to be repaired.

Specifically, after performing the repairing on the image block to be repaired based on the target image block, some unknown pixels in the region to be repaired are repaired to become known pixels, and therefore, the region to be repaired is reduced to become a new region to be repaired, at this time, based on the new region to be repaired, the target image block with the highest matching degree with the image block to be repaired of the new region to be repaired may be determined according to the image block to be repaired in the new region to be repaired and the edge information image block in the second image, and the new region to be repaired is repaired based on the target image block, as such repetitive cycling, so that the region to be repaired is continuously reduced, and finally the first image may be repaired as a complete image.

According to embodiments of the present disclosure, when the target image block matched with the image block to be repaired is determined in the non-to-be-repaired region, not only the known pixel of the image block to be repaired is considered, but also the edge information of the edge information image block corresponding to the image block to be repaired is considered, so that the determined edge information in the target image block may be caused to be more matched with the edge information of the edge information image block, so that after the image block to be repaired is repaired based on the target image block, the alignment effect of the line in the image block to be repaired after repairing and the line in the adjacent image block is better, making the improvement to the problem that the line in the original region to be repaired and the original non-to-be-repaired region cannot be aligned after image repairing, and the image repairing effect is improved.

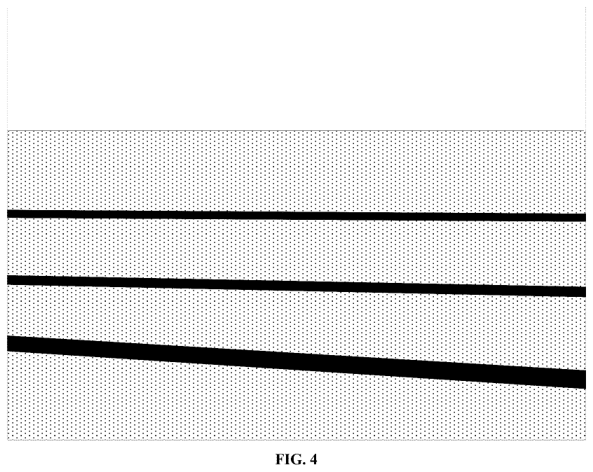

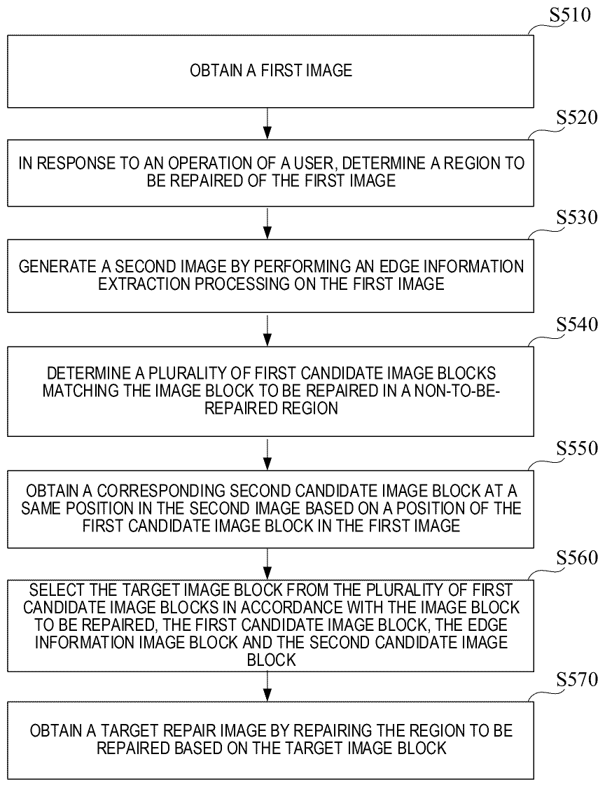

As an example, FIG. 4 is a schematic diagram of a first image after repairing provided by embodiments of the present disclosure. As shown in FIG. 2 and FIG. 4, after performing image repairing on FIG. 2, a complete image is obtained, as shown in FIG. 4.

According to embodiments of the present disclosure, when the target image block matched with the image block to be repaired is determined in the non-to-be-repaired region, not only the known pixel of the image block to be repaired is considered, but also the edge information of the edge information image block corresponding to the image block to be repaired is considered, so that the determined edge information in the target image block may be caused to be more matched with the edge information of the edge information image block, so that after the image block to be repaired is repaired based on the target image block, the alignment effect of the line in the image block to be repaired after repairing and the line in the adjacent image block is better, making the improvement to the problem that the line in the original region to be repaired and the original non-to-be-repaired region cannot be aligned after image repairing, and the image repairing effect is improved.

FIG. 5 is a schematic flowchart of another method for image processing provided by embodiments of the present disclosure. Embodiments of the present disclosure are optimized based on the foregoing embodiments, and embodiments of the present disclosure may be combined with each optional solutions of the foregoing one or more embodiments.

As shown in FIG. 5, the method for image processing may include the following steps.

S510: obtain a first image.

Specifically, S510 is similar to S110, and details are not described herein again.

S520: in response to an operation of a user, determine a region to be repaired of the first image.

Specifically, S520 is similar to S120, and details are not described herein again.

S530: generate a second image by performing an edge information extraction processing on the first image.

Specifically, S530 is similar to S130, and details are not described herein again.

S540: determine a plurality of first candidate image blocks matching the image block to be repaired in a non-to-be-repaired region.

Specifically, the size of the first candidate image block is the same as the size of the image block to be repaired.

In some embodiments, S540 may include: randomly selecting the plurality of first candidate image blocks matching the image block to be repaired in the non-to-be-repaired region.

In some other embodiments, S540 may include: S541: determining a candidate matching region in the non-to-be-repaired region according to a position of the image block to be repaired.

Specifically, the candidate matching region belongs to the non-to-be-repaired region.

In one example, S541 may include: determining a region of a predetermined shape with a predetermined distance from the position of the image block to be repaired as the candidate matching region.

Specifically, the predetermined distance and the predetermined shape may be set according to actual conditions by those skilled in the art, which is not limited herein.

In another example, S541 may include: determining a candidate matching region corresponding to the image block to be repaired according to a position of a target image block corresponding to an image block to be repaired adjacent to the image block to be repaired, where the target image block corresponding to the image block to be repaired adjacent to the image block to be repaired is located in a candidate matching region corresponding to the image block to be repaired.

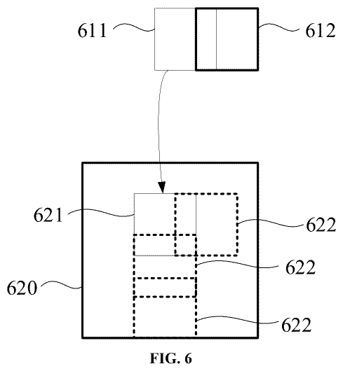

As an example, FIG. 6 is a schematic logical diagram of determining a candidate matching region provided by embodiments of the present disclosure. As shown in FIG. 6, a third image block to be repaired 611 corresponds to the third target image block 621, and a candidate matching region 620 corresponding to the fourth image block to be repaired 612 is determined according to the position of the third target image block 621.

It can be understood that the local region in the image usually has a structural consistency, that is, the similarity between different image blocks in the local region is relatively high, and therefore, the candidate matching region is determined in the non-to-be-repaired region according to the position of the image block to be repaired, which is beneficial for the candidate matching region being located near or in the same local region of the image block to be repaired, so that the similarity between the first candidate image block determined in the candidate matching region and the image block to be repaired is relatively high, which is beneficial to subsequent search of the target image block with fewer search times.

S542, according to a size of the image block to be repaired, determine a plurality of first candidate image blocks matching the image block to be repaired in the candidate matching region according to a predetermined random algorithm and a pixel adjustment value.

Specifically, any possible random algorithm may be used, which is not limited thereto. In addition, the specific value of the pixel adjustment value may be set according to actual conditions by those skilled in the art, which is not limited herein.

In one example, S542 may include: according to the size of the image block to be repaired, randomly select at least one first candidate image block in the candidate matching region according to the predetermined random algorithm; and according to the size of the image block to be repaired, obtaining the first candidate image block at a location of offsetting the pixel adjustment value on a predetermined direction based on the location of the randomly selected first candidate image block, where the pixel adjustment values corresponding to different predetermined directions may be same or different, which is not limited herein.

As an example, continue to referring to FIG. 6, according to the size of the fourth image block to be repaired 612, three first candidate image blocks 622 matching the fourth image block to be repaired 612 are determined in the candidate matching region 620 according to the predetermined random algorithm and the pixel adjustment value.

In another example, S542 may include: according to the size of the image block to be repaired, randomly select a plurality of first candidate image blocks in the candidate matching region according to the predetermined random algorithm, where a distance between any two first candidate image blocks is greater than or equal to the pixel adjustment value.

It can be understood that, determining the plurality of first candidate image blocks in the candidate matching region according to the predetermined random algorithm and the pixel adjustment value, may cause the plurality of first candidate image blocks to be uniformly scattered located in the candidate matching region, so as to avoid aggregation of the plurality of first candidate image blocks, thereby avoiding the risk of being difficult to find the target image block having higher matching degree due to the plurality of first candidate image blocks being too similar.

S550: obtain a corresponding second candidate image block at a same position in the second image based on a position of the first candidate image block in the first image.

Specifically, the manner of obtaining the second candidate image block is similar to the manner of obtaining the edge information image block, and details are not described herein again.

S560: select the target image block from the plurality of first candidate image blocks in accordance with the image block to be repaired, the first candidate image block, the edge information image block and the second candidate image block.

In some embodiments, S560 may include: obtaining a fourth model for selecting an image block having a highest matching degree with the image block to be repaired, wherein the fourth model is generated by pre-training according to the image block to be repaired in the image sample set, a plurality of first candidate image blocks and a plurality of second candidate image blocks corresponding to the image block to be repaired, and the image block having the highest matching degree; and inputting the image block to be repaired, the plurality of first candidate image blocks and the plurality of second candidate image blocks corresponding to the image block to be repaired into the fourth model for processing, and outputting the target image block having the highest matching degree with the image block to be repaired.

In some other embodiments, S560 may include: S561, obtain a pixel difference value based on a known pixel of the image block to be repaired and a pixel value of each the first candidate image block.

Specifically, a pixel difference value between the image block to be repaired and each the first candidate image block is obtained based on the known pixel of the image block to be repaired and the pixel value of each the first candidate image block.

S562: obtain an edge difference value based on an edge value of the edge information image block and an edge value of each the second candidate image block.

Specifically, the edge value is used to represent a line feature of the image.

Specifically, an edge difference between the edge information image block and each second candidate image block is obtained based on the edge value of the edge information image block and the edge value of each second candidate image block.

S563: obtain a loss value of the image block to be repaired and each the first candidate image block based on the pixel difference value and the edge difference value, a first candidate image block corresponding to a minimum loss value being as the target image block.

Specifically, the minimum loss value is a minimum value among the loss values corresponding to a plurality of first candidate image blocks.

In one example, S563 may include: obtain a first calculation result by calculating a square of the pixel difference value; obtain a second calculation result by calculating a square of the edge difference value; obtain a loss value of the image block to be repaired and each first candidate image block by summing the first calculation result and the second calculation result, and using the first candidate image block corresponding to the minimum loss value as the target image block having the highest matching degree with the image block to be repaired.

Certainly, the first calculation result may also be obtained by calculating the third power or the fourth power of the pixel difference, and the second calculation result may also be obtained by calculating the third power or the fourth power of the edge difference. However, it is not limited thereto.

It can be understood that the first candidate image block corresponding to the minimum loss value is used as the target image block, which may cause the manner of selecting the target image block to be simple, which is beneficial to reducing the performance requirement on the electronic device.

S570, obtain a target repair image by repairing the region to be repaired based on the target image block.

Specifically, S570 is similar to S150, and details are not described herein again.

According to embodiments of the present disclosure, by determining a plurality of first candidate image blocks matching with the image block to be repaired and the second candidate image blocks corresponding to the plurality of first candidate image blocks, and according to known pixels of the image block to be repaired, pixels of each first candidate image block, the edge information image block and edge information of each second candidate image block, selecting the target image block having a highest matching degree with the image block to be repaired from the plurality of first candidate image blocks may cause the target image block to be selected from the plurality of first candidate image blocks, which is beneficial for finding the target image block which is more matching with the image block to be repaired or more suitable for repairing the image block to be repaired, and therefore, it is beneficial for the alignment effect of the line in the image block to be repaired after repairing and the line in the image block adjacent to the image block to be repaired to be further improved, and the image repairing effect is further improved.

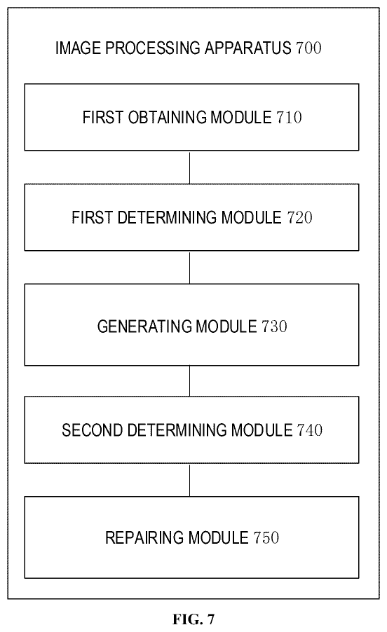

FIG. 7 is a schematic structural diagram of an apparatus for image processing provided by embodiments of the present disclosure. As shown in FIG. 7, the image processing apparatus 700 includes:
a first obtaining module 710 configured to obtain a first image;
a first determining module 720 configured to in response to an operation of a user, determine a region to be repaired of the first image;
a generating module 730 configured to generate a second image by performing an edge information extraction processing on the first image;
a second determining module 740 configured to determine, in accordance with an image block to be repaired of the region to be repaired and an edge information image block in the second image, a target image block having a highest matching degree with the image block to be repaired; and
a repairing module 750 configured to obtain a target repair image by repairing the region to be repaired based on the target image block.

In another implement of the present disclosure, the generating module 730 may include:
a first obtaining submodule configured to obtain a first model for performing a low-resolution repair on a region to be repaired in an image;
a second obtaining submodule configured to obtain a third image by inputting the first image into the first model; and
an extracting submodule configured to generate the second image by performing an edge information extraction processing on the third image.

In another implement of the present disclosure, the apparatus may further include:
a dividing module configured to divide an image block to be repaired comprising a known pixel and an unknown pixel in accordance with an edge of the region to be repaired; and
a second obtaining module configured to obtain an edge information image block corresponding to the image block to be repaired at a same position in the second image based on a position of the image block to be repaired in the first image.

In another implement of the present disclosure, the second determining module 740 may include:
a first determining submodule configured to determine a plurality of first candidate image blocks matching the image block to be repaired in a non-to-be-repaired region; and
a third obtaining submodule configured to obtain a corresponding second candidate image block at a same position in the second image based on a position of the first candidate image block in the first image; and
a selecting submodule configured to select the target image block from the plurality of first candidate image blocks in accordance with the image block to be repaired, the first candidate image block, the edge information image block and the second candidate image block.

In another implement of the present disclosure, the first determining submodule may include:
a first determining unit configured to determine a candidate matching region in the non-to-be-repaired region in accordance with a position of the image block to be repaired; and
a second determining unit configured to in accordance with a size of the image block to be repaired, determine a plurality of first candidate image blocks matching the image block to be repaired in the candidate matching region according to a predetermined random algorithm and a pixel adjustment value.

In another implement of the present disclosure, the selecting submodule may include:
a first obtaining unit configured to obtain a pixel difference value based on a known pixel of the image block to be repaired and a pixel value of each the first candidate image block;
a second obtaining unit configured to obtain an edge difference value based on an edge value of the edge information image block and an edge value of each the second candidate image block; and
a third determining unit configured to obtain a loss value of the image block to be repaired and each the first candidate image block based on the pixel difference value and the edge difference value, a first candidate image block corresponding to a minimum loss value being as the target image block.

In another implement of the present disclosure, the repairing module 750 may include:
a second determining submodule configured to determine, in the target image block, a first pixel region corresponding to a known pixel in the image block to be repaired and a second pixel region corresponding to an unknown pixel in the image block to be repaired; and
an updating submodule configured to fill a pixel value of the second pixel region into a corresponding position of an unknown pixel in the image block to be repaired, and perform an update processing on a corresponding position of a known pixel in the image block to be repaired based on a pixel value of the first pixel region.

The apparatus provided in embodiments can perform the method of any of the foregoing embodiments, and the execution manner and beneficial effects thereof are similar, and details are not described herein again.

Embodiments of the present disclosure further provide an electronic device, including: a memory storing a computer program; and a processor, configured to execute the computer program, when the computer program is executed by the processor, the method of any of the foregoing embodiments may be implemented.

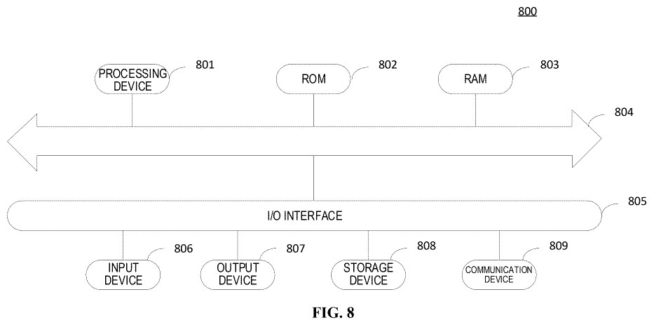

As an example, FIG. 8 is a schematic diagram of a structure of an electronic device in accordance with embodiments of the present disclosure. Reference is made to FIG. 8 in details below, which illustrates a schematic diagram of a structure of an electronic device 800 appliable for implementing embodiments of the present disclosure. The electronic device 800 may include, but not limited to mobile terminals such as mobile phones, notebook computers, digital broadcast receivers, personal digital assistant (PDA), portable Android device (PAD), portable multimedia player (PMP), vehicle-mounted terminals (such as vehicle-mounted navigation terminals), etc., as well as fixed terminals such as digital television (TV), desktop computers, etc. The electronic device shown in FIG. 8 is only an example, and should not limit the function and application range of embodiments of the present disclosure.

As shown in FIG. 8, the electronic device 800 may include a processing device (such as a central processing unit, a graphics processing unit, or the like) 801 that may perform various appropriate actions and processing according to a program stored in a read only memory (ROM) 802 or a program loaded from a storage device 808 into a random access memory (RAM) 803. In the RAM 803, various programs and data required for operation of the electronic device 800 are further stored. The processing device 801, the ROM 802, and the RAM 803 are connected to each other by using a bus 804. An input/output (I/O) interface 805 is also connected to the bus 804.

Generally, the following devices may be connected to the I/O interface 805: input device 806 including, for example, a touchscreen, a touchpad, a keyboard, a mouse, a camera, a microphone, an accelerometer, and a gyroscope, etc.; output device 807 including, for example, a liquid crystal display (LCD), a loudspeaker and a vibrator, etc.; storage device 808 including, for example, a tape or a hard disk; and a communication device 809. The communication device 809 may allow the electronic device 800 to communicate wirelessly or by wire with another device to exchange data. Although FIG. 8 shows an electronic device 800 with various devices, it should be understood that it is not required to implement or provide all shown devices. Alternatively, more or fewer devices may be implemented or provided.

In particular, according to embodiments of the present disclosure, the process described above with reference to the flowchart may be implemented as a computer software program. For example, embodiments of the present disclosure include a computer program product that includes a computer program carried on a non-transitory computer readable medium, and the computer program includes program codes used to perform the methods shown in the flowchart. In such embodiments, the computer program may be downloaded and installed from a network by using the communications device 809, or installed from the storage device 808, or installed from the ROM 802. When the computer program is executed by the processing device 801, the foregoing functions defined in the method in embodiments of the present disclosure are executed.

It should be noted that the foregoing computer-readable medium in the present disclosure may be a computer-readable signal medium, a computer-readable storage medium, or any combination of both of the above. The computer-readable storage medium may be but not limited to, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, radio frequency (RF), etc., or any suitable combination thereof.

In some implementations, the client, server may communicate using any currently known or future developed network protocol, such as HyperText Transfer Protocol (HTTP), and may be interconnected with any form or medium of digital data communication (e.g., a communication network). Examples of communication network include local area network (“LAN”), wide area networks (“WAN”), internets (e.g., the Internet), and peer-to-peer networks (e.g., ad hoc peer-to-peer networks), as well as any currently known or future developed networks.

The foregoing computer-readable medium may be included in the foregoing electronic device; it may also exist separately without being assembled into the electronic device.

The foregoing computer-readable medium carries one or more programs, when the foregoing one or more programs are executed by the electronic device, causing the electronic device to:
obtain a first image;
in response to an operation of a user, determine a region to be repaired of the first image;
generate a second image by performing an edge information extraction processing on the first image;
determine, in accordance with an image block to be repaired of the region to be repaired and an edge information image block in the second image, a target image block having a highest matching degree with the image block to be repaired;
obtain a target repair image by repairing the region to be repaired based on the target image block.

Computer program codes for performing the operations of the present disclosure may be written in one or more programming languages or a combination thereof, the foregoing programming languages including but not limit to object oriented programming languages, such as Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and block diagrams in the accompanying drawings illustrate possible architectures, functions, and operations of systems, methods, computer program products and computer programs according to various embodiments of the present disclosure. In this regard, each block in a flowchart or block diagram may represent a unit, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units involved in embodiments described in the present disclosure may be implemented either by means of software or by means of hardware. The names of these units do not limit the units themselves under certain circumstances.

The functions described above herein may be performed, at least in part, by one or more hardware logic components. For example, and without limitation, example types of hardware logic components that may be used include: field programmable gate arrays (FPGAs), application specific integrated circuits (ASICs), application specific standard part (ASSP), systems on-a-chip (SOC), complex programmable logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM) or flash memory, optical fiber, portable compact disc read-only memory (CD-ROM), optical storage device, magnetic storage device, or any suitable combination of the foregoing content.

Embodiments of the present disclosure further provides a computer-readable storage medium, the storage medium storing a computer program, and when the computer program is executed by a processor, the method of any of the foregoing embodiments may be implemented, and the execution manner and beneficial effects thereof are similar, and details are not described herein again.

It should be noted that, relational terms herein such as “first” and “second” are merely used to distinguish one entity or operation from another entity or operation, and do not necessarily require or imply that any such actual relationship or sequence exists between these entities or operations. Moreover, the terms “including”, “comprising,” or any other variation thereof are intended to cover a non-exclusive inclusion, such that a process, method, item, or device including a series of elements includes not only those elements, but also other elements not expressly listed, or elements inherent to such process, method, item, or apparatus. Without further restriction, the elements defined by the statement “include one” do not preclude the presence of additional identical elements in the process, method, item, or device that includes the elements.

The foregoing is only specific embodiments of the present disclosure, causing that those skilled in the art can understand or implement the present disclosure. Various modifications to these embodiments will be apparent to those skilled in the art, the general principles defined herein may be implemented in other embodiments without departing from the spirit or scope of the present disclosure. Accordingly, the present disclosure will not be limited to these embodiments described herein, but is to be accorded with the widest scope consistent with the principles and novel features disclosed herein.

1. A method for image processing, comprising:
obtaining a first image;
in response to an operation of a user, determining a region to be repaired of the first image;
generating a second image by performing an edge information extraction processing on the first image;
determining, in accordance with an image block to be repaired of the region to be repaired and an edge information image block in the second image, a target image block having a highest matching degree with the image block to be repaired; and
obtaining a target repair image by repairing the region to be repaired based on the target image block.

2. The method of claim 1, wherein generating the second image by performing the edge information extraction processing on the first image comprises:
obtaining a first model for performing a low-resolution repair on a region to be repaired in an image;
obtaining a third image by inputting the first image into the first model; and
generating the second image by performing an edge information extraction processing on the third image.

3. The method of claim 1, further comprising:
dividing an image block to be repaired comprising a known pixel and an unknown pixel in accordance with an edge of the region to be repaired; and
obtaining an edge information image block corresponding to the image block to be repaired at a same position in the second image based on a position of the image block to be repaired in the first image.

4. The method of claim 1, wherein determining, in accordance with the image block to be repaired of the region to be repaired and the edge information image block in the second image, the target image block having the highest matching degree with the image block to be repaired comprises:
determining a plurality of first candidate image blocks matching the image block to be repaired in a non-to-be-repaired region;
obtaining a corresponding second candidate image block at a same position in the second image based on a position of the first candidate image block in the first image; and
selecting the target image block from the plurality of first candidate image blocks in accordance with the image block to be repaired, the first candidate image block, the edge information image block and the second candidate image block.

5. The method of claim 4, wherein determining the plurality of first candidate image blocks matching the image block to be repaired in the non-to-be-repaired region comprises:
determining a candidate matching region in the non-to-be-repaired region in accordance with a position of the image block to be repaired; and
in accordance with a size of the image block to be repaired, determining a plurality of first candidate image blocks matching the image block to be repaired in the candidate matching region according to a predetermined random algorithm and a pixel adjustment value.

6. The method of claim 4, wherein selecting the target image block from the plurality of first candidate image blocks in accordance with the image block to be repaired, the first candidate image block, the edge information image block and the second candidate image block comprises:
obtaining a pixel difference value based on a known pixel of the image block to be repaired and a pixel value of each the first candidate image block; and
obtaining an edge difference value based on an edge value of the edge information image block and an edge value of each the second candidate image block;
obtaining a loss value of the image block to be repaired and each the first candidate image block based on the pixel difference value and the edge difference value, a first candidate image block corresponding to a minimum loss value being as the target image block.

7. The method of claim 1, wherein repairing the image block to be repaired based on the target image block comprises:
determining, in the target image block, a first pixel region corresponding to a known pixel in the image block to be repaired and a second pixel region corresponding to an unknown pixel in the image block to be repaired; and
filling a pixel value of the second pixel region into a corresponding position of the unknown pixel in the image block to be repaired, and performing an update processing on a corresponding position of the known pixel in the image block to be repaired based on a pixel value of the first pixel region.

8. (canceled)

9. An electronic device, comprising:
a processor and a memory, wherein the memory stores a computer program, when the computer program is executed by the processor, the processor performs acts comprising:
obtaining a first image;
in response to an operation of a user, determining a region to be repaired of the first image;
generating a second image by performing an edge information extraction processing on the first image;
determining, in accordance with an image block to be repaired of the region to be repaired and an edge information image block in the second image, a target image block having a highest matching degree with the image block to be repaired; and
obtaining a target repair image by repairing the region to be repaired based on the target image block.

10-11. (canceled)

12. The electronic device of claim 9, wherein generating the second image by performing the edge information extraction processing on the first image comprises:
obtaining a first model for performing a low-resolution repair on a region to be repaired in an image;
obtaining a third image by inputting the first image into the first model; and
generating the second image by performing an edge information extraction processing on the third image.

13. The electronic device of claim 9, the acts further comprising:
dividing an image block to be repaired comprising a known pixel and an unknown pixel in accordance with an edge of the region to be repaired; and
obtaining an edge information image block corresponding to the image block to be repaired at a same position in the second image based on a position of the image block to be repaired in the first image.

14. The electronic device of claim 9, wherein determining, in accordance with the image block to be repaired of the region to be repaired and the edge information image block in the second image, the target image block having the highest matching degree with the image block to be repaired comprises:
determining a plurality of first candidate image blocks matching the image block to be repaired in a non-to-be-repaired region;
obtaining a corresponding second candidate image block at a same position in the second image based on a position of the first candidate image block in the first image; and
selecting the target image block from the plurality of first candidate image blocks in accordance with the image block to be repaired, the first candidate image block, the edge information image block and the second candidate image block.

15. The electronic device of claim 14, wherein determining the plurality of first candidate image blocks matching the image block to be repaired in the non-to-be-repaired region comprises:
determining a candidate matching region in the non-to-be-repaired region in accordance with a position of the image block to be repaired; and
in accordance with a size of the image block to be repaired, determining a plurality of first candidate image blocks matching the image block to be repaired in the candidate matching region according to a predetermined random algorithm and a pixel adjustment value.

16. The electronic device of claim 14, wherein selecting the target image block from the plurality of first candidate image blocks in accordance with the image block to be repaired, the first candidate image block, the edge information image block and the second candidate image block comprises:
obtaining a pixel difference value based on a known pixel of the image block to be repaired and a pixel value of each the first candidate image block;
obtaining an edge difference value based on an edge value of the edge information image block and an edge value of each the second candidate image block; and
obtaining a loss value of the image block to be repaired and each the first candidate image block based on the pixel difference value and the edge difference value, a first candidate image block corresponding to a minimum loss value being as the target image block.

17. The electronic device of claim 9, wherein repairing the image block to be repaired based on the target image block comprises:
determining, in the target image block, a first pixel region corresponding to a known pixel in the image block to be repaired and a second pixel region corresponding to an unknown pixel in the image block to be repaired; and
filling a pixel value of the second pixel region into a corresponding position of the unknown pixel in the image block to be repaired, and performing an update processing on a corresponding position of the known pixel in the image block to be repaired based on a pixel value of the first pixel region.

18. A non-transitory computer-readable storage medium storing a computer program, when the computer program is executed by a processor, is configured to perform acts comprising:
obtaining a first image;
in response to an operation of a user, determining a region to be repaired of the first image;
generating a second image by performing an edge information extraction processing on the first image;
determining, in accordance with an image block to be repaired of the region to be repaired and an edge information image block in the second image, a target image block having a highest matching degree with the image block to be repaired; and
obtaining a target repair image by repairing the region to be repaired based on the target image block.

19. The non-transitory computer-readable storage medium of claim 18, wherein generating the second image by performing the edge information extraction processing on the first image comprises:
obtaining a first model for performing a low-resolution repair on a region to be repaired in an image;
obtaining a third image by inputting the first image into the first model; and
generating the second image by performing an edge information extraction processing on the third image.

20. The non-transitory computer-readable storage medium of claim 18, the acts further comprising:
dividing an image block to be repaired comprising a known pixel and an unknown pixel in accordance with an edge of the region to be repaired; and
obtaining an edge information image block corresponding to the image block to be repaired at a same position in the second image based on a position of the image block to be repaired in the first image.

21. The non-transitory computer-readable storage medium of claim 18, wherein determining, in accordance with the image block to be repaired of the region to be repaired and the edge information image block in the second image, the target image block having the highest matching degree with the image block to be repaired comprises:
determining a plurality of first candidate image blocks matching the image block to be repaired in a non-to-be-repaired region;
obtaining a corresponding second candidate image block at a same position in the second image based on a position of the first candidate image block in the first image; and
selecting the target image block from the plurality of first candidate image blocks in accordance with the image block to be repaired, the first candidate image block, the edge information image block and the second candidate image block.

22. The non-transitory computer-readable storage medium of claim 21, wherein determining the plurality of first candidate image blocks matching the image block to be repaired in the non-to-be-repaired region comprises:
determining a candidate matching region in the non-to-be-repaired region in accordance with a position of the image block to be repaired; and
in accordance with a size of the image block to be repaired, determining a plurality of first candidate image blocks matching the image block to be repaired in the candidate matching region according to a predetermined random algorithm and a pixel adjustment value.

23. The non-transitory computer-readable storage medium of claim 21, wherein selecting the target image block from the plurality of first candidate image blocks in accordance with the image block to be repaired, the first candidate image block, the edge information image block and the second candidate image block comprises:
obtaining a pixel difference value based on a known pixel of the image block to be repaired and a pixel value of each the first candidate image block;
obtaining an edge difference value based on an edge value of the edge information image block and an edge value of each the second candidate image block; and
obtaining a loss value of the image block to be repaired and each the first candidate image block based on the pixel difference value and the edge difference value, a first candidate image block corresponding to a minimum loss value being as the target image block.
